(19) United States
(12) Patent Application Publication
(10) Pub. No.: US 2008/0073823 A1
(43) Pub. Date: Mar. 27, 2008

(54) Clamp structure

(76) Inventor: Tung-Chuan Lin, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/524,461

(22) Filed: Sep. 21, 2006

(51) Int. Cl. B25B 1/14

(52) U.S. Cl. 269/228

(57) ABSTRACT

An improved clamp structure includes a workbench, and the workbench has a quick release unit that can be turned linearly and a baffle board. A front clamping board and a rear clamping board are disposed between the quick release unit and the baffle board. An axial rod connects the front clamping board and quick release unit, and two guiding rods penetrate through the front and rear clamping boards to assist the sliding of the front and rear clamping boards. A link rod module is installed separately on the left and right walls of the front and rear clamping boards for controlling the quick release unit, such that when the axial rod drives the front clamping board to move, the front clamping board can be linked to the rear clamping board by the two link rod modules, so as to define corresponding quick opening and closing movements between the front and rear clamping boards.

### BACKGROUND OF THE INVENTION

1. Field of the Invention

The present invention relates to an improved clamp structure, and more particularly to a clamp that clamps a workpiece or places a workpiece in a position for facilitating the manufacture of the workpiece.

2. Description of the Related Art

Referring to FIG. 8 for a traditional clamp, the clamp includes a front clamping board 51, a rear clamping board 52, two guiding rods 53 passing between the front and rear clamping boards 51, 52 for assisting their sliding, an axial rod 54 passing through the front and rear clamping boards 51, 52, two opposite-direction screw threads 541, 542 disposed at penetrating positions of a rod body of the axial rod 54 corresponding to the front and rear clamping boards 51, 52, two opposite-direction screw threads 511, 521 disposed separately on an internal wall of a hole at a penetrating position of the front and rear clamping boards 51, 52 and passed by the axial rod 54, and a turning portion 55 disposed at an end of the front clamping board 51 and away from the axial rod 54, such that if the turning portion 55 is turned, the axial rod 54 will be rotated, and the opposite-direction screw threads drive the front and rear clamping boards 51, 52 to move towards each other or away from each other for opening or closing movements.

The aforementioned traditional clamp uses the opposite-direction screw thread sections to drive the clamp to open and close, but there are still some drawbacks in practical applications. For example, the method of rotating the axial rod is inconvenient, which takes much time and efforts. If an auxiliary rod (not shown in the figure) perpendicular to the axial rod is adopted to rotate the axial rod, it can reduce the time a little, but strictly speaking, such arrangement is still inconvenient. In the method of using opposite-direction screw threads to drive the axial rod to rotate, the screw threads may be stripped by an improper use, and the rotation of the axial rod will become unsmooth, and thus the prior arts require further improvements.

### SUMMARY OF THE INVENTION

Therefore, it is a primary objective of the present invention to overcome the shortcomings of the prior art by providing an improved clamp structure that connects a front clamping board to a quick release unit and installs a link rod module between the front and rear clamping boards, such that after the front and rear clamping boards are driven by the quick release unit, the clamp can be opened or closed quickly.

To achieve the foregoing objective, the present invention comprises:

a workbench, having a quick release unit and a baffle board disposed far apart from each other;

a front clamping board and a rear clamping board, disposed between the quick release unit and the baffle board, and parallel to each other;

an axial rod, installed on the quick release unit, and having an end away from the quick release unit coupled to the central position of the front clamping board;

two symmetric guiding rods, being parallel to the axial rod, and penetrating through the front and rear clamping boards at the positions away from both sides of the axial center of the axial rod, and an end of each guiding rod away from the rear clamping board being fixed onto the baffle board;

two cross-shape link rod modules, and each link rod module being pivotally coupled to the central position for a pivotal movement, wherein a link rod module connects the right walls of the front and rear clamping boards and another link rod module connects the left walls of the front and rear clamping boards; and

the quick release unit is controlled, such that when the axial rod drives the front clamping board to move, the front clamping board drives the rear clamping board by the two link rod modules, and thus relative opening and closing movements can be performed between the front and rear clamping boards.

The objectives, shape, structure, apparatus, characteristics and effects will become apparent by the detail description together with the accompanying drawings. Of course, some of the elements of the present invention may be substituted by their equivalents, and the detailed description of preferred embodiments given in the specification illustrates the structure of the invention.

### BRIEF DESCRIPTION OF THE DRAWINGS

FIG. 1 is a perspective view of the present invention;

FIG. 2 is a planar view of FIG. 1;

FIG. 3 is a planar view of FIG. 1 showing a status of pulling open the pulling portion;

FIG. 4 is a schematic view of front and rear clamping boards clamping a square workpiece in accordance with the present invention;

FIG. 5 is a schematic view of a way of connecting a screw thread section and a front clamping board in accordance with the present invention;

FIG. 6 is a schematic view of placing a cylindrical workpiece on a chamfer structure at the top of front and rear clamping boards in accordance with the present invention;

FIG. 7 is a schematic view of another way of connecting a screw thread section and a front clamping board in accordance with the present invention; and

FIG. 8 is a schematic planar view of a traditional clamp.

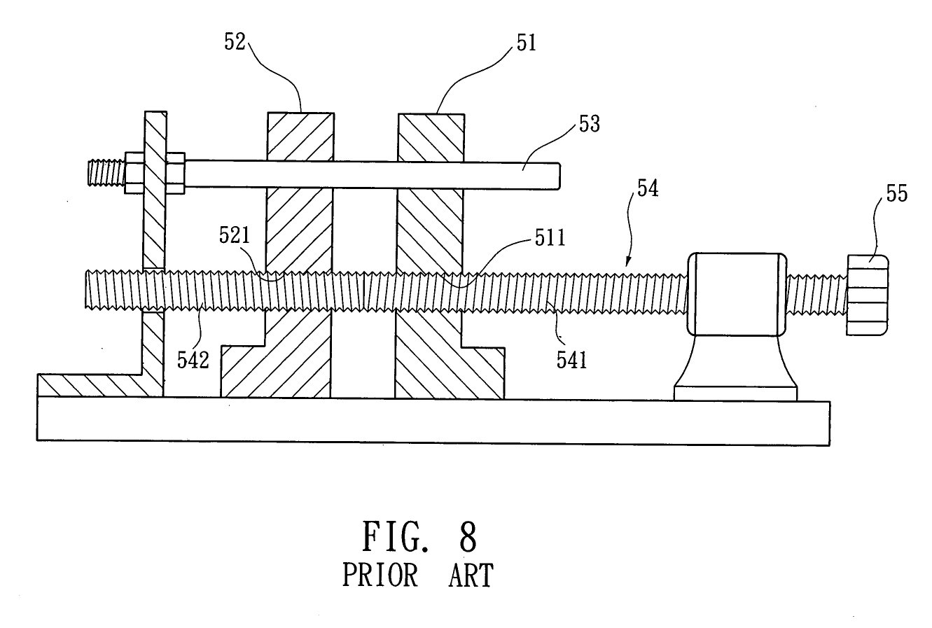

### DETAILED DESCRIPTION OF THE PREFERRED EMBODIMENTS

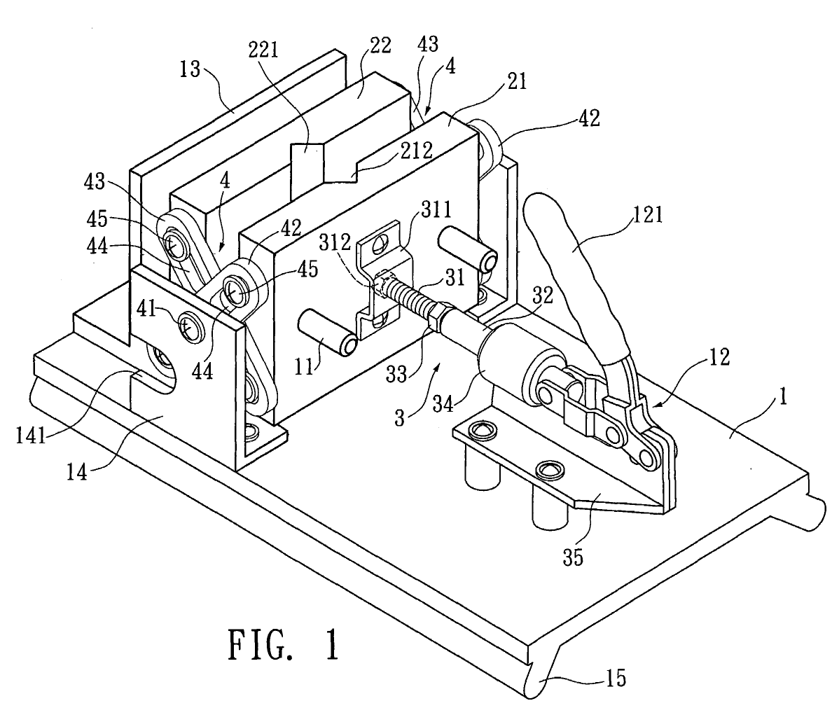

Referring to FIGS. 1 to 7, a structure in accordance to a preferred embodiment of the present invention is used for illustration, and not intended to limit the scope of patent claims of the invention.

Referring to FIGS. 1 to 3 for a preferred embodiment of an improved clamp structure in accordance with the present invention, the improved clamp structure comprises a workbench 1, a front clamping board 21, a rear clamping board 22, an axial rod 3, two symmetric guiding rods 11 and two cross-shape link rod modules 4.

The workbench 1 includes a quick release unit 12 and a baffle board 13 which are disposed with a distance apart from each other and can be turned linearly, and the quick release unit 12 has a pulling portion 121, such that a force can be applied to the quick release unit 12 conveniently, and the front and rear clamping boards 21, 22 are disposed between the quick release unit 12 and the baffle board 13, and the front and rear clamping boards 21, 22 are parallel to each other, wherein the front clamping board 21 is disposed proximate to the quick release unit 12.

The axial rod 3 is installed on the quick release unit 12, and the axial rod 3 has an end away from the quick release unit 12 being coupled to the central position of the front clamping board 21. In this embodiment, the axial rod 3 includes a screw thread section 31 and a shaft tube 32, and the screw thread section 31 can be moved inward and outward inside the shaft tube 32, and the screw thread section 31 has a turning member 33, such that a force can be applied conveniently to the turning member 33, and an end of the screw thread section 31 away from the shaft tube 32 is coupled to the central position of the front clamping board 21, such that the screw thread section 31 can be tuned to drive the front clamping board 21 to move.

Further, the shaft tube 32 passes through a shaft base 34 and connects the quick release unit 12, and the quick release unit 12 and the shaft base 34 are disposed on a base 35, and the base 35 is disposed on the workbench 1.

In this embodiment, a connecting member 311 is disposed between the front clamping board 21 and the screw thread section 31 and fixed at the central position of an external wall of the front clamping board 21, and the screw thread section 31 of the axial rod 3 is connected to the connecting member 311 by a fixing member 312.

The two guiding rods 11 are parallel to the axial rod 3 and penetrated through the front and rear clamping boards 21, 22 on both sides of the axial center of the axial rod 3, and an end of each guiding rods 11 away from the rear clamping board 22 is fixed onto the baffle board 13.

Each link rod module 4 is pivotally coupled to the central position for a pivotal movement, wherein a link rod module 4 connects the right walls of the front and rear clamping boards 21, 22 and another link rod module 4 connects the left walls of the front and rear clamping boards 21, 22. In this embodiment, a pivot member 41 is pivotally coupled to the central pivotal connecting position of each link rod module 4 and the pivot member 41 has an L-shape board member 14 installed thereon. The bottom of the board member 14 is fixed onto the workbench 1, and two opposite sides which are away from each other and disposed at the bottom of the front and rear clamping boards 21, 22 correspond to the L-shape bottom of the board member 14, and the board member 14 has a track groove 141 disposed at a position corresponding to the bottom of the rear clamping board 22.

Each link rod module 4 is described in details as follows:

In this embodiment, each link rod module 4 has a first link rod 42 and a second link rod 43, and the first and second link rods 42, 43 are intersected at their central positions and pivotally coupled at their central positions by the pivot member 41, and the rod bodies of the first and second link rods 42, 43 separately have a track groove 44 disposed on their pivotal position, wherein the track grooves 44 separately disposed on both ends of the first link rod 42 of the two link rod modules 4 correspond to the top and bottom of the left and right walls of the front and rear clamping boards 21, 22 respectively, and the track grooves 44 separately disposed on both ends of the second link rod 43 correspond to the top and bottom of the left and right walls of the front and rear clamping boards 21, 22, and each track groove 44 has a fixing member 45 passing therein, and the fixing member 45 is installed separately at the top and bottom of the left and right walls of the front and rear clamping boards 21, 22, so as to define relative movements between the fixing member 45 and the track groove 44. Further, the fixing member 45 disposed at the bottom of the rear clamping board 22 corresponds to the track groove 141 of the board member 14, such that the fixing member 45 can be exposed from the track groove 141 for facilitating the installation and removal.

The quick release unit 12 is controlled, such that when the axial rod 3 drives the front clamping board 21 to move, the front clamping board 21 links the rear clamping board 22 by the two link rod modules 4, and thus relative opening and closing movements are defined between the front and rear clamping boards 21, 22.

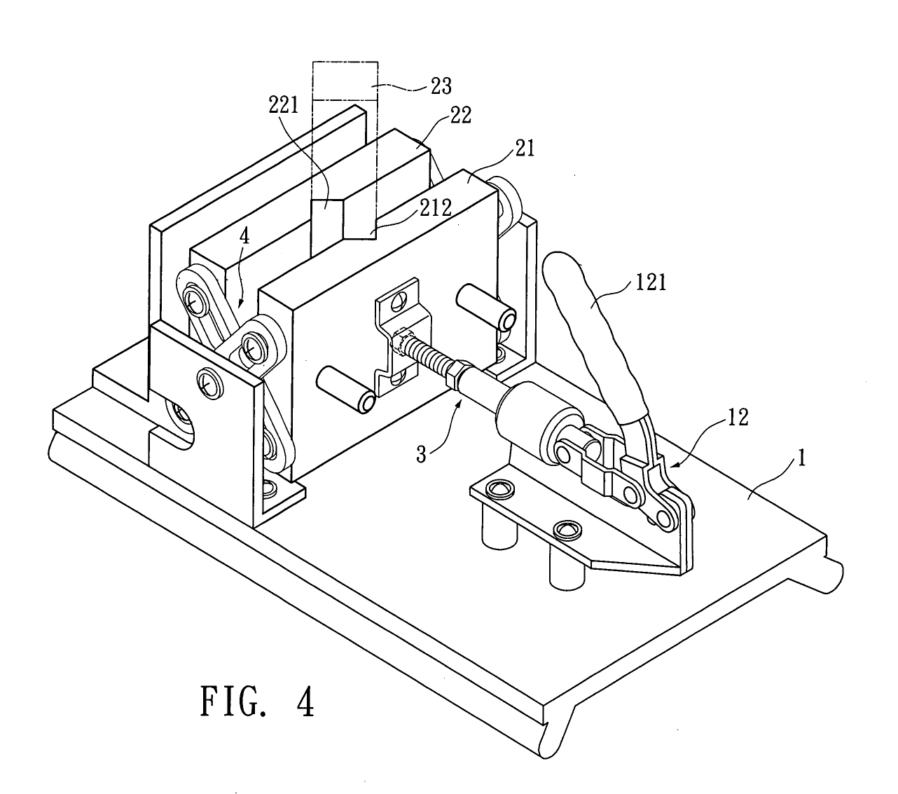

In this embodiment, at least one longitudinal and corresponding first recession 212 and second recession 221 disposed on both internal walls adjacent to the front and rear clamping boards 21, 22, and a square workpiece 23 can be placed between the first and second recessions 212, 221 for its manufacture as shown in FIG. 4.

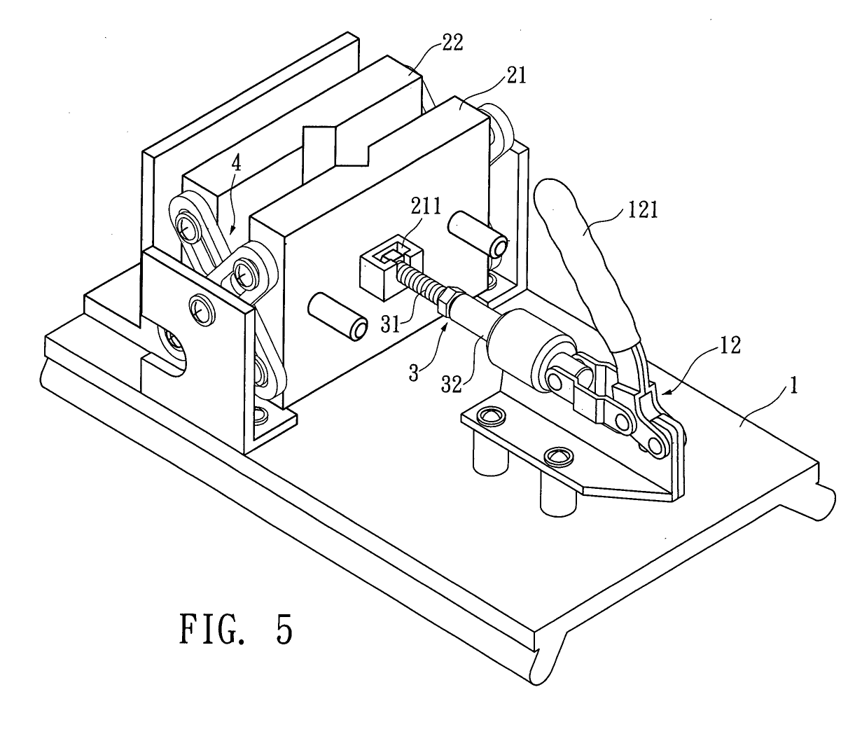

In addition, another method can be applied for connecting the screw thread section 31 and the front clamping board 21. In this method, the front clamping board 21 at its central position has a groove 211, and an end of the screw thread section 31 away from the shaft tube 32 is disposed in the groove 211 as shown in FIG. 5.

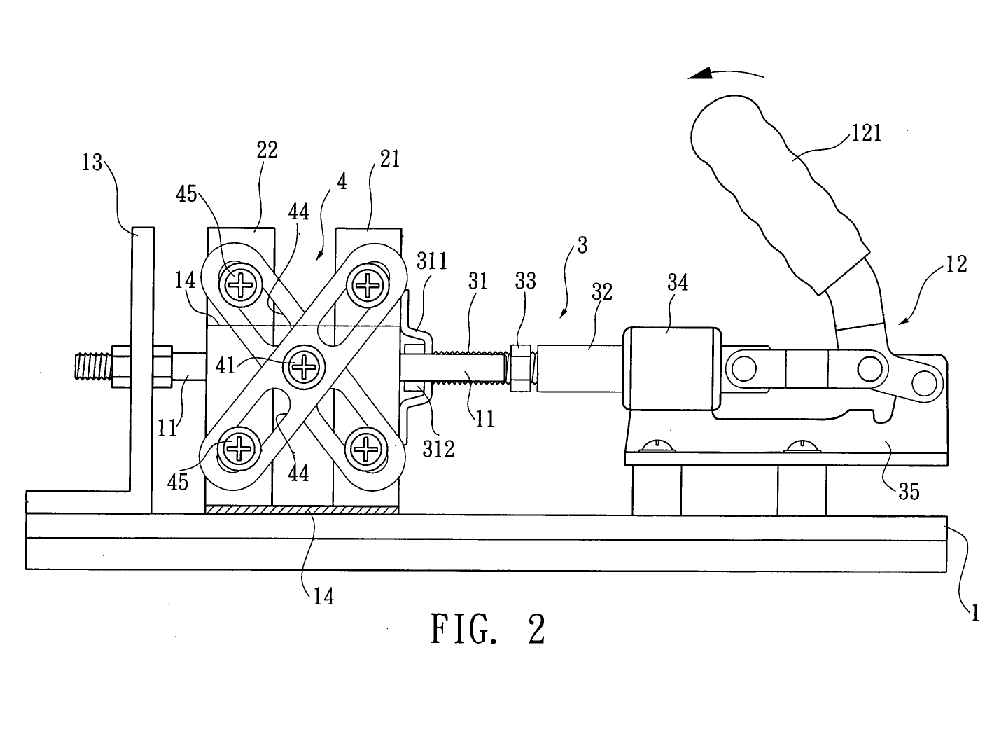

In this method, the pulling portion 121 of the quick release unit 12 is turned towards the axial rod 3, and then the front clamping board 21 is pushed by the axial rod 3 to move towards the rear clamping board 22. Since the two link rod modules 4 are installed between the front and rear clamping boards 21, 22, the rear clamping board 22 is linked by the two link rod modules 4 to move towards the front clamping board 21 at the same time when the front clamping board 21 moves towards the rear clamping board 22, such that if a force is applied to turn the quick release unit 12, the clamping motion between the front and rear clamping boards 21, 22 can be performed quickly to clamp the workpiece as shown in FIGS. 2 and 4, so as to clamp a bar-shaped square workpiece 23 for facilitating the manufacture of the workpiece 23.

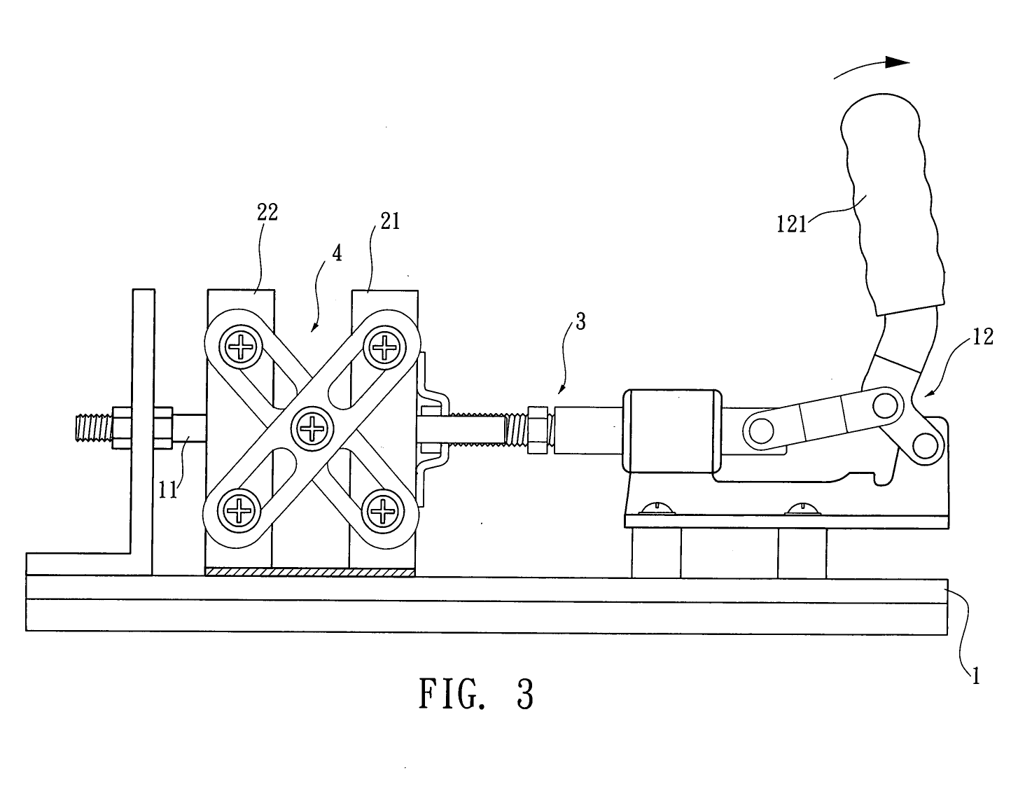

If it is necessary to remove the workpiece from a position between the front and rear clamping boards 21, 22, then the pulling portion 121 of the quick release unit 12 is turned in a direction away from the axial rod 3, so as to quickly separate the front and rear clamping boards 21, 22 in order to remove the workpiece as shown in FIG. 3. The pulling portion 121 can be substituted by an equivalent pneumatic or electric component, so as to make it easier and quicker for the quick release unit 12 to drive and move the front and rear clamping boards 21, 22.

Further, the screw thread section 31 on the axial rod 3 is connected to the front clamping board 21, such that if it is necessary to make a fine tune, the turning member 33 is turned to control the traveling direction of the screw thread section 31. If it is necessary to clamp the workpiece more tightly by the front and rear clamping boards 21, 22, then the turning member 33 on the screw thread section 31 turns the shaft tube 32. Since the screw thread section 31 and the turning member 33 are fixed with each other, therefore the screw thread section 31 can be driven to move. On the other hand, if it is necessary to loosen the workpiece, then the turning member 33 is turned towards the shaft tube 32.

In summation of the description above, the present invention has an advantage of using the linear pulling of the quick release unit 12 and the installation of the two link rod modules 4 to quickly achieve the opening and closing movements of the front and rear clamping boards 21, 22.

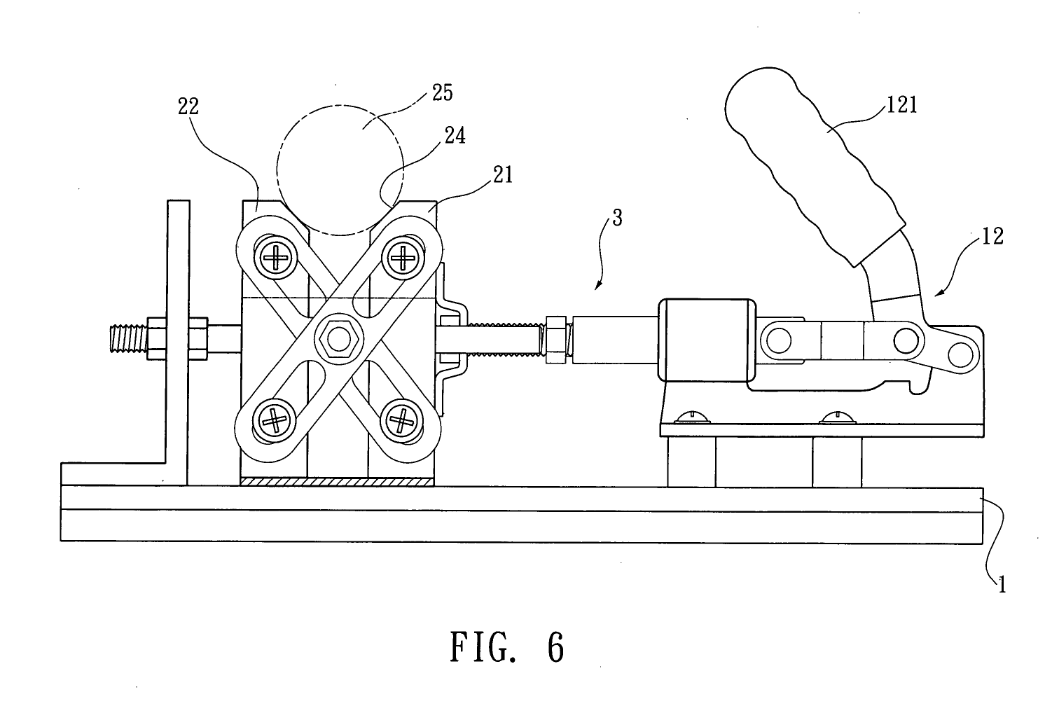

Of course, the present invention still has other embodiments, and minor variations can be made in these embodiments. Referring to FIG. 6 for a second preferred embodiment of the present invention, transversal and corresponding chamfer structures 24 are formed respectively on two internal edges adjacent to the top of the front and rear clamping boards 21, 22 for placing a cylindrical workpiece 25 between the two chamfer structures 24 for the manufacture of the workpiece 25.

Therefore, the workpieces of different shapes can be placed at this position for facilitating the manufacture of the workpiece.

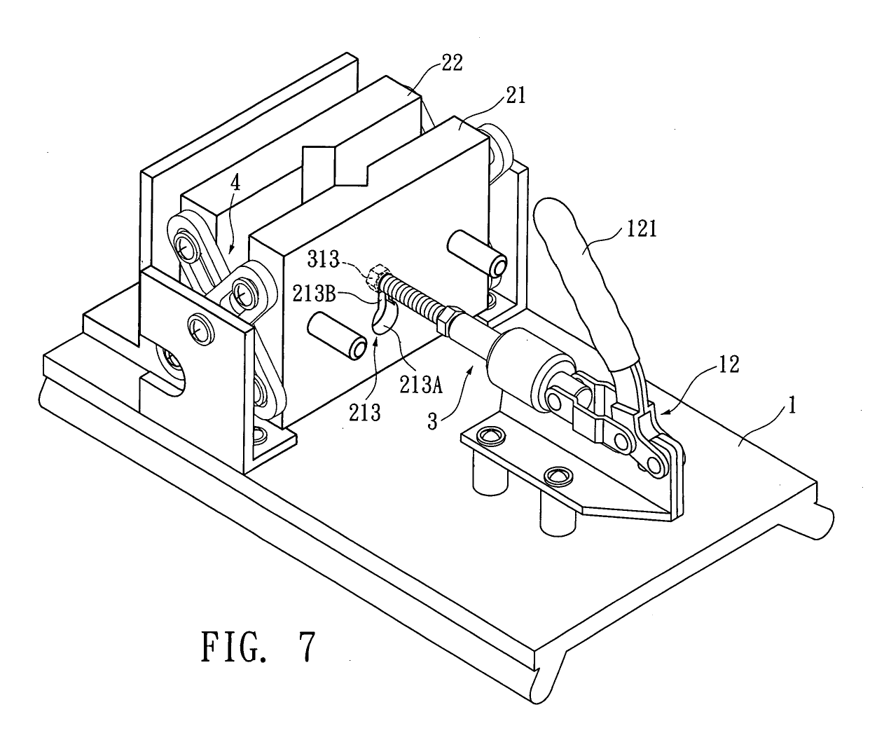

Referring to FIG. 7, another way of connecting the screw thread section 31 and the front clamping board 21 is disclosed. The front clamping board 21 in its middle forms a recession 213, and the recession 213 has a passing hole 213A and a limit hole 213B smaller than the passing hole 213A, and an end the screw thread section 31 away from the shaft tube 32 is disposed in the recession 213, wherein an end of the screw thread section 31 has a fixing member 313 passing through the passing hole 213A, and fixed upwardly in the limit hole 213B, so as to connect the screw thread section 31 and the front clamping board 21.

Further, a plurality of support portions 15 are disposed on the lateral sides at the bottom of the workbench 1, and one of the support portions 15 is disposed on a longer side at the bottom of the workbench 1 as shown in FIG. 1 for securely supporting the workbench in a working area having miscellaneous objects.

While the invention has been described by means of a specific numerous modifications and variations could be made thereto by those skilled in the art without departing from the scope and spirit of he invention set forth in the claims.

In summation of the above description, the present invention definitely achieves the expected objective and provides an improved clamp structure to enhance the performance over the prior art. The invention further complies with the patent application requirements and is duly filed for the patent application.

What is claimed is:

1. An improved clamp structure, comprising:
a workbench, having a quick release unit and a baffle board disposed apart from each other;
a front clamping board and a rear clamping board, disposed between said quick release unit and said baffle board, and said front and rear clamping boards being parallel to each other;
an axial rod, installed on said quick release unit, and an end of said axial rod away from said quick release unit being coupled to the central position of said front clamping board;
two symmetric guiding rods, being parallel to said axial rod, and penetrating through said front and rear clamping boards at positions away from both sides of an axial center of said axial rod, and an end of said each guiding rod away from said rear clamping board being fixed onto said baffle board; and
two cross-shape link rod modules, each pivotally coupled at a central position of said link rod module for a pivotal movement, wherein a link rod module connects the right walls of said front and rear clamping boards, and another link rod module connects the left walls of said front and rear clamping boards;
thereby, said quick release unit is controlled, such that when said axial rod drives said front clamping board to move, said front clamping board links said rear clamping board by said two link rod modules to define relative opening and closing movements between said front and rear clamping boards.

2. The improved clamp structure of claim 1, wherein said each link rod module has a pivot member disposed at the central pivotal position of said link rod module and installed on a board member, and the bottom of said board member is fixed onto said workbench.

3. The improved clamp structure of claim 1, wherein said each link rod module has a first link rod and a second link rod, and said first and second link rods are intersected at their central positions and pivotally coupled to the central positions by a pivot member, and said first and second link rods have a track groove disposed separately on the rod bodies at both ends of their pivotal position, and said track grooves disposed on both ends of said first link rod of said two link rod modules correspond to the top and bottom of the left and right walls of said front and rear clamping boards respectively, and said track grooves disposed on both ends of said second link rod correspond to the top and bottom of the left and right walls of said front and rear clamping boards respectively, and said each track groove is passed with a fixing member, and said fixing member is installed separately at the top and bottom of the left and right walls of said front and rear clamping boards to define relative movements between said fixing member and said track groove.

4. The improved clamp structure of claim 1, wherein said axial rod includes a screw thread section and a shaft tube, and said screw thread section can be moved spirally inward and outward inside said shaft tube, and said screw thread section includes a turning member such that a force can be applied conveniently, and an end of said screw thread section away from said shaft tube is coupled to the central position of said front clamping board, so as to fine tune said front clamping board after said screw thread section is moved spirally.

5. The improved clamp structure of claim 4, further comprising a connecting member disposed between said front clamping board and said screw thread section and fixed at the central position of an external wall of said front clamping board, and said axial rod screw thread section is coupled to said connecting member.

6. The improved clamp structure of claim 4, wherein said front clamping board has a groove disposed at the central position of said front clamping board, and an end of said screw thread section away from said shaft tube is disposed in said groove.

7. The improved clamp structure of claim 4, wherein said shaft tube is penetrated through a shaft base and coupled to said quick release unit, and said quick release unit and said shaft base are disposed separately on a base, and said base is disposed on said workbench.

8. The improved clamp structure of claim 1, wherein said quick release unit has a pulling portion, such that a force can be applied onto said pulling portion conveniently.

9. The improved clamp structure of claim 1, wherein said front and rear clamping boards have at least one longitudinal and corresponding first recession and second recession separately disposed at two adjacent internal walls of said front and rear clamping boards.

10. The improved clamp structure of claim 9, wherein said first and second recessions are provided for placing a square workpiece for the manufacture of said square workpiece.

11. The improved clamp structure of claim 1, wherein said front and rear clamping boards form transversal and corresponding chamfer structures at both internal edges adjacent to the top of said front and rear clamping boards.

12. The improved clamp structure of claim 11, wherein said two chamfer structures are provided for placing a cylindrical workpiece for the manufacture of said cylindrical workpiece.

13. The improved clamp structure of claim 4, wherein said front clamping board forms a recession at the center of the interior of said front clamping board, and an end of said screw thread section away from said shaft tube is disposed in said recession.

14. The improved clamp structure of claim 1, wherein said board member has a track groove disposed at a position corresponding to the bottom of said rear clamping board.

15. The improved clamp structure of claim 1, wherein said workbench has a plurality of support portions disposed on lateral sides of the bottom of said workbench.

16. The improved clamp structure of claim 8, wherein said pulling portion is driven pneumatically or electrically.
